(19) United States
(12) Patent Application Publication
(10) Pub. No.: US 2008/0232526 A1
(43) Pub. Date: Sep. 25, 2008

(54) Digital signal processing employing a clock frequency which is always a constant integer multiple of the fundamental frequency of an input analog signal

(76) Inventor: Brian J. Kaczynski, San Francisco, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/728,147

(22) Filed: Mar. 23, 2007

(51) Int. Cl. H04L 7/04

(52) U.S. Cl. 375/362

(57) ABSTRACT

A method and apparatus are disclosed for clocking a DSP at a frequency which is always a constant integer multiple of the fundamental frequency of the input analog signal. This invention applies in situations where the analog signal exhibits certain characteristics in which a fixed clock frequency is not desired, but rather what is needed is a clock which tracks the fundamental frequency of the analog signal, for example, a signal from a monophonic musical instrument or a polyphonic instrument being played one note at a time.

### BACKGROUND OF THE INVENTION

1. Field of the Invention

The present invention relates generally to the field of digital signal processing and more particularly to a method and apparatus for generating a DSP clock signal which always tracks the fundamental frequency of an input analog signal.

2. Background Art

Traditionally, digital signal processors employ a clock running at a constant frequency. However, there are circumstances where it would be preferable to employ a clock frequency which is always a constant integer multiple of the fundamental frequency of the input analog signal. By way of example, a music synthesizer which employs DSP to modify each harmonic component of a monophonic analog signal would benefit from always having a clock frequency which is a constant integer multiple of the fundamental frequency of the input analog signal.

### SUMMARY OF THE INVENTION

This invention relates to situations in which Digital Signal Processing (DSP) is performed on analog signals which have been digitized using an A/D converter. Usually, DSP employs a clock which runs at a constant frequency, often the same rate as the sample rate of the A/D converter. In this manner, for example, filters can be easily designed to attenuate the input signal in certain fixed frequency bands. High-pass and low-pass filters are two-well-known examples of this application.

This invention applies in situations where the analog signal exhibits certain characteristics in which a fixed clock frequency is not desired, but rather what is needed is a clock which tracks the fundamental frequency of the analog signal, for example, a signal from a monophonic musical instrument (any instrument which cannot play multiple notes together) or a polyphonic instrument being played “one note at a time”. This invention relates to a method and apparatus for clocking the DSP at a frequency which is always a constant integer multiple of the fundamental frequency of the input analog signal.

One example of a DSP application where it is highly advantageous to use a clock frequency which tracks the fundamental frequency of the input analog signal, is disclosed in co-pending patent application Ser. No. ______ filed on even date herewith and entitled FREQUENCY-TRACKED SYNTHESIZER EMPLOYING SELECTIVE HARMONIC AMPLIFICATION.

### BRIEF DESCRIPTION OF THE DRAWINGS

The various embodiments, features and advances of the present invention will be understood more completely hereinafter as a result of a detailed description thereof in which reference will be made to the following drawings:

FIG. 1 is a block diagram of a system for deriving the fundamental frequency of the input analog signal and employing an integer multiple of that frequency to clock a DSP system;

FIG. 2 is a block diagram of a fundamental frequency detector used in the system of FIG. 1; and

FIG. 3 is a block diagram of a frequency multiplier used in the preferred embodiment of the invention and comprising a phase-locked loop (PLL) with a loss of signal input.

### DETAILED DESCRIPTION OF A PREFERRED EMBODIMENT

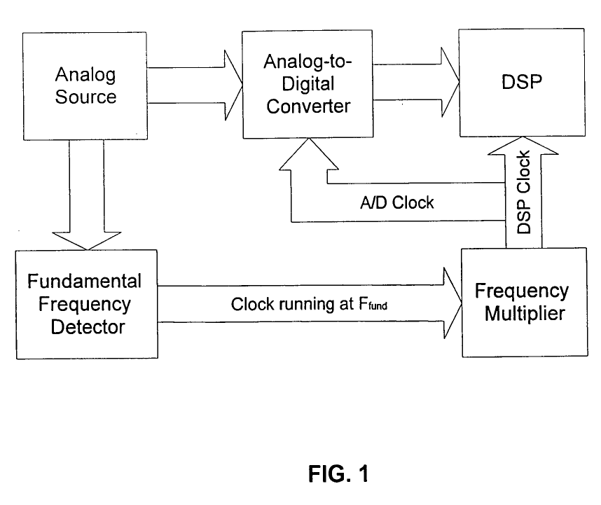

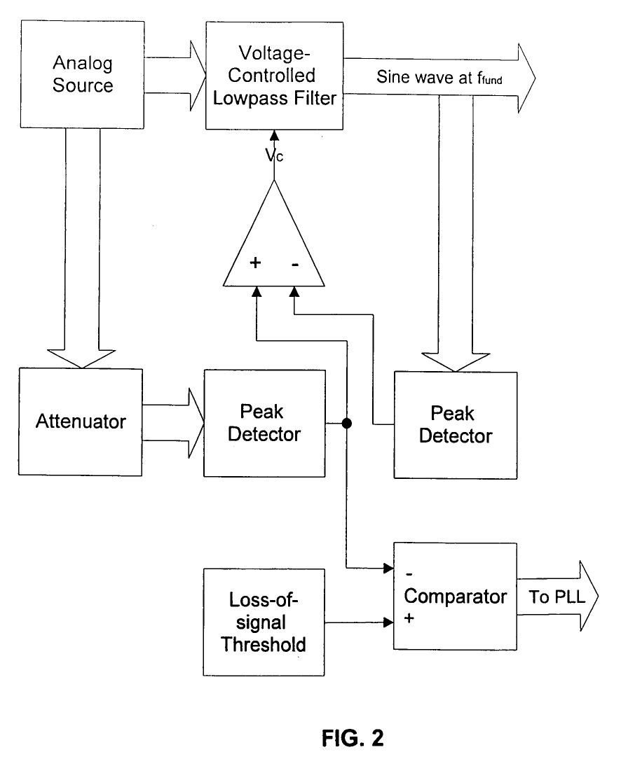

FIG. 1 illustrates a preferred embodiment which in its broadest sense comprises a detector for determining the fundamental frequency of the analog signal and a frequency multiplier for generating a clock signal having a frequency which is a precise constant multiple of the fundamental frequency. In further detail, the fundamental frequency tracking circuit may be implemented by passing the input signal through a voltage-controlled low-pass filter in a servo loop which forces a fixed amount of attenuation, as shown in FIG. 2. This loop is designed to sufficiently eliminate the higher-order harmonics present in the input signal in order to yield substantially a “sine wave” at the fundamental frequency of the input signal.

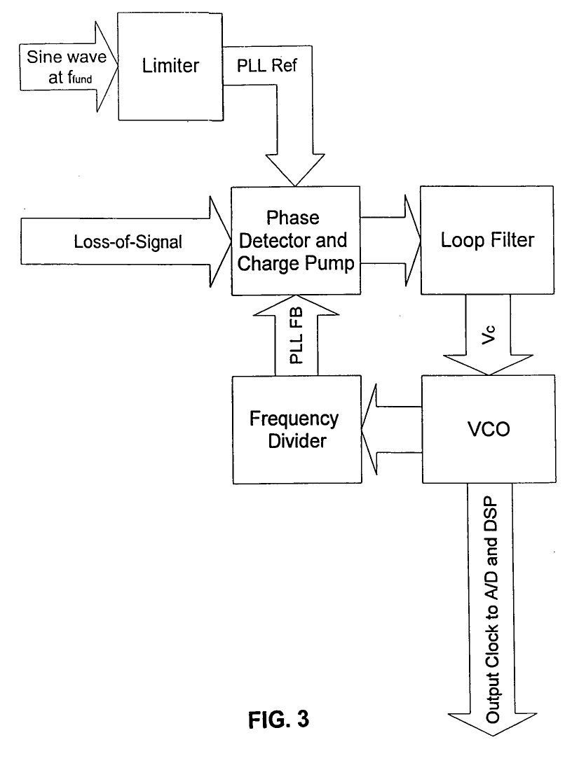

Further, the frequency-multiplying circuit necessary for generating the clock for the A/D converter and DSP may be an analog Phase-Locked Loop (PLL), shown in FIG. 3. PLLs can be designed according to a known art and are well understood. The fundamental frequency detector, shown in FIG. 2, operates as follows: An input analog signal is attenuated and this attenuated signal is passed through a peak detector. The output of this peak detector represents a “reference signal”. The analog signal is also passed through a voltage-controlled low-pass filter and the output of this filter is passed through a second peak detector. The difference between the output of this second peak detector and the reference signal is amplified by an error amplifier and fed back as the control voltage to the filter. In the steady state, both peak detectors are outputting the same level, thus the low-pass filter has sufficiently eliminated the higher-order harmonics in the input analog signal so that the output of the voltage-controlled low-pass filter represents a sine wave at the fundamental frequency of the input analog signal.

A “threshold monitor” circuit shown in FIG. 2 generates a control signal to be output to the PLL. This circuit monitors the reference signal by comparing it to a fixed reference threshold. If the reference signal drops below this threshold value, the comparator outputs a “Loss of Signal” bit which will disable the feedback action of the PLL in an attempt to “hold” the current locked frequency.

The PLL, shown in FIG. 3, has only one additional feature compared to the typical PLL. When the analog input signal gets too small and the “Loss of Signal” bit is set, the charge pump is disabled and the loop filter attempts to “hold” the current control voltage until the analog input signal returns to a healthy amplitude, and the PLL reference clock becomes valid again.

Having thus disclosed a preferred embodiment of the present invention, it will now be seen that there may be various alternative ways for carrying out the invention, as well as certain modifications that could be made to the described embodiment while still realizing the advantageous features and benefits thereof. Therefore, the scope of protection sought herein should not necessarily be deemed to be limited by the disclosed embodiment. The invention hereof should be deemed to be defined only by the appended claims and their equivalents.

I claim:

1. A method of tracking the fundamental frequency of an analog signal for controlling the clock signal rate of a DSP system receiving the analog signal, to be a constant integer multiple of that fundamental frequency; the method comprising the steps of:
a) passing said analog signal to a fundamental frequency detector to generate a sine wave running at said fundamental frequency; and
b) applying said sine wave to a frequency multiplier to generate said clock signal.

2. The method recited in claim 1 further comprising the steps of c) connecting said analog signal to an analog-to-digital converter and d) clocking said analog-to-digital converter at said generated clock rate.

3. The method recited in claim 1 wherein step a) comprises the steps of:
c) applying the input analog signal to both a voltage-controlled low-pass filter and an attenuator;
d) connecting the output of the attenuator to a first peak detector to produce a reference signal;
e) connecting the output of the voltage-controlled low-pass filter to a second peak detector;
f) finding the difference between the reference signal and the output of the second peak detector and amplifying that difference; and
g) applying the amplified difference of step f) as the control voltage to the voltage controlled low-pass filter.

4. The method recited in claim 3 further comprising the steps of comparing said reference signal to a fixed reference threshold and generating a Loss of Signal output whenever the magnitude of a said reference signals falls below the magnitude of said threshold.

5. The method recited in claim 1 wherein step b) comprises the steps of:
applying said sine wave to a phase-locked loop containing a voltage-controlled oscillator and a frequency divider for locking the output frequency of the oscillator to the frequency of the sine wave as an integral multiple thereof.

6. The method recited in claim 4 wherein step b) comprises the steps of:
applying said sine wave to a phase locked loop containing a voltage-controlled oscillator and a frequency divider for locking the output frequency of the oscillator to the frequency of the sine wave as an integral multiple thereof;
wherein said phase-locked loop comprises a phase detector and charge pump and a loop filter, said phase detector and charge pump receiving said Loss of Signal output for disabling said charge pump and causing said loop filter to hold a constant oscillator control voltage until the magnitude of said reference signal exceeds the magnitude of said threshold.

7. An apparatus for tracking the fundamental frequency of an analog signal for controlling the clock signal rate of a DSP system receiving the analog signal, to be a constant integer multiple of that fundamental frequency; the apparatus comprising:
a fundamental frequency detector generating a sine wave running at said fundamental frequency; and
a frequency multiplier receiving said fundamental frequency sine wave and generating said clock signal of said DSP system therefrom.

8. The apparatus recited in claim 7 further comprising an analog-to-digital converter, said analog-to-digital converter being clocked by said clock signal.

9. The apparatus recited in claim 7 wherein said fundamental frequency detector comprises a voltage-controlled low-pass filter and an attenuator; and a first peak detector connected to said attenuator;
a second peak detector connected to the output of said voltage-controlled low-pass filter;
an amplifier connected to said first and second peak detectors for amplifying the difference between outputs of said peak detectors and connecting that amplified difference to said voltage-controlled low-pass filter.

10. The apparatus recited in claim 7 wherein said frequency multiplier comprises a phase-locked loop containing a voltage-controlled oscillator and a frequency divider locking the output frequency of said oscillator to the frequency of the sine wave as an integral multiple thereof.

11. In combination with a digital signal processor connected to an analog-to-digital converter for generating a digital representation of an analog signal to be acted upon by the digital signal processor; an apparatus for controlling a clock signal used by the digital signal processor, the apparatus comprising:
a detector for generating a sine wave having a frequency that is the fundamental frequency of said analog signal; and
a frequency multiplier for generating said clock signal at a frequency which is a precise selected multiple of said fundamental frequency of said sine wave.

12. In the combination recited in claim 11 the apparatus further comprising a voltage controlled low-pass filter producing said sine wave.

13. In the combination recited in claim 11 the apparatus further comprising a phase-locked loop having a voltage-controlled oscillator producing said clock signal.

14. In the combination recited in claim 11, the apparatus connecting said clock signal to said analog-to-digital converter as an A/D clock.

15. In the combination recited in claim 13, said phase-locked loop further comprising a Loss of Signal device for locking said voltage-controlled oscillator at its most recent frequency whenever said analog signal has a magnitude that falls below a selected threshold.

16. A digital signal processor receiving an analog signal and comprising a clock having an automatically alterable frequency, said clock frequency always being a constant multiple of the fundamental frequency of said analog signal.
